(19) United States
(12) Patent Application Publication
(10) Pub. No.: US 2002/0147066 A1
(43) Pub. Date: Oct. 10, 2002

(54) Traction-based differential

(76) Inventor: Evgeny I. Rivin, West Bloomfield, MI (US)

Correspondence Address: EVGENY I RIVIN, 4227 FOX POINTE DRIVE, WEST BLOOMFIELD, MI, 48323

(21) Appl. No.: 09/827,722

(22) Filed: Apr. 6, 2001

(51) Int. Cl. F16H 13/06; F16H 48/08

(52) U.S. Cl. 475/184

(57) ABSTRACT

A differential mechanism connecting two shafts and/or wheels, allowing for rotation of these shafts/wheels with different angular speeds, and having frictional connections between its sun gears and planets.

### FIELD OF THE INVENTION

The present invention relates to differential mechanisms, especially for automotive applications.

### BACKGROUND OF THE INVENTION

Steering of wheeled self-propelled vehicles results in different length trajectories traveled by left and right wheels of the driving axle. If the latter is of a solid design, significant sliding of the wheels would ensue. This would lead to fast and uneven wear of wheel treads, energy losses, annoying noise, etc. To avoid these undesirable effects, the driving axle is usually designed as comprised of two half-axles connected via a differential mechanism. A conventional differential mechanism has two bevel sun gears with both of which several planets are engaged. The planets are rotationally mounted on the carrier driven from the drive shaft. When the vehicle goes straight, both sun gears (each attached to one half-axle supporting one wheel) are rotating with the same speed as the driven carrier, and there is no relative motion between the planets and the sun gears (i.e., the planets do not rotate on their axes). When the vehicle is steered and thus goes along a circular arc trajectory, the outside wheel covers a longer trajectory, while the inside wheel covers a shorter one. During this event, planets are rotating on their axes thus resulting in a faster rotation of the outboard sun gear (and the respective wheel) and a slower rotation of the inboard sun gear (and the respective wheel), thus preventing sliding of the wheels on the ground.

Although many designs of gear-based differentials had been proposed, they have the similar basic design concept. Conventional gear differentials are used in tens of millions of vehicles, but they have some shortcomings. One shortcoming is their cost since relatively expensive bevel gears are used for the sun gears and for the planets. It can be noted that these expensive components are not utilized to their full potential since they are only intermittently used for limited displacements during the steering events. Complexity of the design also results in excessive weight and size of the mechanism. While importance of weight reduction for modem vehicles does not require elaboration, it has to be emphasized that diameter of the differential housing is determining the clearance height of the vehicle, especially for rear-wheel-drive vehicles. A serious shortcoming is very low resistance of the mechanism to relative displacements of the connected half-axles. While this feature is beneficial for steering, it results in poor performance of the vehicle in cases when sliding friction is very different for the left and right driving wheels, e.g. when one wheel is moving on a very slippery surface (ice or water) while the other wheel is moving on a regular high friction road surface. In such cases, the wheel on the slippery surface spins without propelling the vehicle while the other wheel does not move at all. Sometimes, expensive mechanical or electronic systems are added to prevent this effect.

Thus, the prior art is represented by rather expensive designs having also some other shortcomings.

### SUMMARY OF THE INVENTION

The present invention teaches a differential mechanism in which the above shortcomings are eliminated or alleviated. The proposed differential comprises housing driven from the vehicle drive shaft and, attached to this housing, carrier of the planetary/differential mechanism, in which the planets are designed as tapered rollers rotating on their axles (pins) and frictionally engaged under preload with two “suns” having tapered surfaces (races) matching with the tapered rollers and attached to the respective half-axles. Such design reduces complexity/cost of the mechanism as well as its weight and size. If the planets are made small in order to reduce the size of the unit, the rolling friction torques exceed those in the conventional gear-based differential. While effect of such increase is insignificant for steering, especially in cases of widely used power-assisted steering, it increases torque transmission on the non-slipping wheel and alleviates the wheel spinning problem of one driving wheel interacting with the slippery surface.

### BRIEF DESCRIPTION OF THE DRAWINGS

FIG. 1 shows axial cross section of a symmetrical embodiment of the proposed differential having two preload-carrying bearings.

### DETAILED DESCRIPTION OF THE PREFERRED EMBODIMENTS

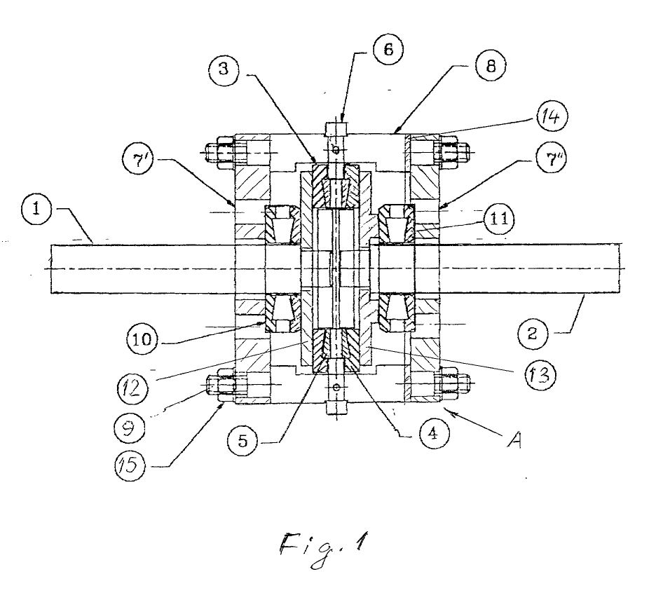

The traction-based differential in FIG. 1 connects half-axles 1 and 2 attached to the driving wheels (not shown) of a vehicle. Housing A is rotationally driven from the drive shaft of the vehicle, e.g., via a hypoid gear (not shown). Housing A is assembled from two side plates 7′, 7″ and several identical pillars 8, with plates 7′ and 7″ and pillars 8 fastened together by threaded studs 9. Each pillar 8 carries planet pin 6 which, in its turn, rotatably carries hollow tapered roller 5. Rollers 5 are squeezed between race members 3 and 4 positively attached to half-axles 1 and 2, respectively. Internal tapered surfaces (races) on race members 3 and 4 have matching taper angles with rollers 5 thus providing line contact between each roller 5 and race plates 3 and 4. While race members 3 and 4 are shown in FIG. 1 as race plates similar to race plates of standard tapered roller thrust bearings, they can be designed to have different shapes as needed to carry additional design functions. Thrust bearing 10 is pressed to race plate 3 by face plate 7′ and spacer 12, thrust bearing 11 is pressed to race plate 4 by face plate 7″ and spacer 13, with the pressing (preload) forces generated by tensioning of studs 9 by tightening nuts 15. Thickness of spacer 14 can be adjusted, e.g. by grinding, to tune the amount of preload between parts 7′, 10, 12, 3, 5, 4, 13, 11, 7″.

In operation, when the vehicle is moving along a straight road providing an adequate grip with the wheels, rotation of both half-axles 1 and 2 has the same speed (rpm) as housing A. The torque is transmitted to the wheels from driven housing A via static sliding friction between rollers 5 and race members 3,4. The magnitude of the static friction is dependent on hardness and surface quality of the contacting rollers and races and on magnitude of the preload force applied by studs 9. During the steering event, half-axle 1 is turning relative to half-axle 2 via rolling friction between rollers 5 and race members 3 and 4. It is known that rolling friction resistance is much lower than sliding friction resistance. However, the rolling friction resistance under preload is usually higher than the corresponding effort required for relative angular displacement between the half-axles in the conventional gear differential. Thus, in case of one wheel loosing its frictional contact with the road, the other wheel would be acted upon with a higher torque than with the conventional gear differential.

It might be beneficial (although it is not required) if the subsystem “race members 3 and 4—rollers 5” can be materialized by using a standard tapered roller thrust bearing. Thrust bearings, especially ones with tapered rollers, are known for exceptionally high allowable thrust forces. For example, Timken T301 bearing (ID=3.0 in., OD=5.25 in.) has the rated load 40,000 lbs. If this load is applied as preload, assuming sliding friction coefficient 0.15, the friction force is 6,000 lbs and the torque transmitted by the sliding friction to each wheel {with the effective radius R_{ef}=½[(3.0+5.25)/2]=˜2.06 in.} is ˜1,000 lb-ft. If a friction-enhancing surface treatment (coating) is used on the races and/or on the rollers, the sliding friction coefficient 0.4-0.5 can be easily attained, while the rolling friction in the connection is not significantly affected. Thus, for the same preload force this torque will be about 3,000 lb-ft. Another means for torque enhancement is increasing number of rolling bodies in the bearing, which is a feasible approach since the arrangement in FIG. 1 retains/supports rollers 5 through the central holes and pins 6 rather than through a cage as in regular tapered roller thrust bearings. The latter design of the retaining action allows for at least 10-15% increase of the number of rollers. It is obvious, that some design embodiments would benefit from using specially designed race members 3 and/or 4, rather than utilizing race plates from off-the-shelf tapered thrust bearings.

It is readily apparent that the components of the differential mechanism disclosed herein may take a variety of configurations. Thus, the embodiments and exemplifications shown and described herein are meant for illustrative purposes only and are not intended to limit the scope of the present invention, the true scope of which is limited solely by the claims appended thereto.

1. A differential mechanism for applying rotation to a pair of coaxial half-axles so as to allow differential motion between the half-axles comprising
a rotationally driven housing;
a plurality of pins affixed to the housing so as to project radially relative to the axis of rotation of the housing;
a plurality of tapered rollers rotationally attached to said pins; and
a pair of thrust bearing housing halves, each affixed to one of the half-axles so that rotational motion of the housing and the attached tapered rollers drives the two bearing housing halves by static sliding force.

2. A differential mechanism for applying rotation to a pair of coaxial half-axles so as to allow differential motion between the half-axles, comprising
a rotationally driven housing;
a plurality of pins fixed to the housing so as to project radially relative to the axis of rotation of the housing;
a plurality of tapered rollers rotationally mounted on said pins;
a pair of race members each having a tapered thrust bearing race, each race member affixed to one of the half-axles so that the tapered race surfaces of said race members frictionally engage with said tapered rollers;
and preload means applying compression force between said tapered race surfaces and said rollers in order to enhance sliding friction force between them, whereby rotational motion of the housing with the attached tapered rollers drives the two said race members by static sliding friction force between said tapered race surfaces and said rollers while inequality of rotational speeds of two half axles is accommodated by rolling friction between said tapered race surfaces and said rollers.

3. A differential mechanism of claim 2, wherein threaded connectors are used as said preload means.

4. A differential mechanism of claim 2, wherein sliding friction coefficient of at least one of said tapered races is enhanced by surface treatment without significantly affecting rolling friction coefficient.

5. A differential mechanism of claim 2, wherein sliding friction coefficient of said rollers is enhanced by surface treatment without significantly affecting rolling friction coefficient.
